(19) United States
(12) Patent Application Publication
(10) Pub. No.: US 2026/0244730 A1
(43) Pub. Date: Aug. 20, 2026

(54) SHAREABLE QR CODE WEB APP USING AUTHENTICATION MECHANISMS

(71) Applicant: 3M INNOVATIVE PROPERTIES COMPANY, St. Paul, MN (US)

(72) Inventors: Sithya S. Khieu, Eden Prairie, MN (US); Caitlin H. Schmocker, Afton, MN (US); Andrew J. Merten, Hastings, MN (US); Jonathan T. Kahl, Woodbury, MN (US)

(21) Appl. No.: 19/159,448

(22) PCT Filed: Feb. 14, 2024
(86) PCT No.: PCT/IB2024/051385

§ 371 Date: Aug. 25, 2025

Related U.S. Application Data
(60) Provisional application No. 63/452,780, filed on Mar. 17, 2023.

(51) Int. Cl. G06F 21/36; G06F 21/62

(52) U.S. Cl. CPC G06F 21/36; G06F 21/6218; G06F 2221/2111; G06F 2221/2141

(57) ABSTRACT

A method includes outputting a scannable identifier onto a physical item. The method also includes configuring the scannable identifier, based upon received configuration input, to grant edit access to specified data based upon subsequent end user authentication. The method also includes configuring the scannable identifier, based upon received configuration input, to grant edit access to specified data based upon subsequent end user authentication receiving, from a previously-authenticated first end user, scan data corresponding to the scannable identifier and first end user authentication data. The method also includes providing, to the first end user, edit access to the specified data based upon the received scan data and first end user authentication data.

### BACKGROUND

Users typically prefer convenient access to data without typing in a web address, also known as a uniform resource locator (URL). Typing in a URL takes time and even a single mistyped character can misdirect the user and/or require retyping the entire URL all over again. While a hyperlink on a webpage can help, hyperlinks are not readily available for scanning in the real world. By contrast, QR codes provide a convenient way to allow users to more quickly and accurately navigate to content such as websites, videos, audio, and the like. A QR code is essentially an array of black and white squares, typically used for storing URLs or other information when scanned. A machine-readable QR code is scanned by a camera on a computing device, or scanned within an existing photo, to direct a user in a manner similar to a typed URL or clicked hyperlink.

### SUMMARY

In one embodiment, one or more non-transitory computer-readable storage media encoded with instructions that, when executed, configure processing circuitry of a computing device to output a scannable identifier onto a physical item. The processing circuitry is further configured to configure the scannable identifier, based upon received configuration input, to grant edit access to specified data based upon subsequent end user authentication. The processing circuitry is further configured to receive, from a first end user, scan data corresponding to the scannable identifier and first end user authentication data. The processing circuitry is further configured to provide, to the first end user, edit access to the specified data based upon the received scan data and first end user authentication data.

In another embodiment, a method includes outputting a scannable identifier onto a physical item. The method also includes configuring the scannable identifier, based upon received configuration input, to grant edit access to specified data based upon subsequent end user authentication. The method also includes configuring the scannable identifier, based upon received configuration input, to grant edit access to specified data based upon subsequent end user authentication receiving, from a previously-authenticated first end user, scan data corresponding to the scannable identifier and first end user authentication data. The method also includes providing, to the first end user, edit access to the specified data based upon the received scan data and first end user authentication data.

In another embodiment, a computing device includes a memory and a processor, wherein the memory is coupled to the processor with the processor being configured to perform operations to output a scannable identifier onto a physical item. The processor is further configured to configure the scannable identifier, based upon received configuration input, to grant edit access to specified data based upon subsequent end user authentication. The processor is further configured to receive, from a first end user, scan data corresponding to the scannable identifier and first end user authentication data. The processor is further configured to provide, to the first end user, edit access to the specified data based upon the received scan data and first end user authentication data.

### BRIEF DESCRIPTION OF THE DRAWINGS

FIG. 1A is a diagram schematically illustrating a smartphone scanning a QR code on a Post-it® Note in accordance with embodiments herein;

FIG. 1B is a diagram schematically illustrating a welcome interface based upon the scanning of a QR code on a Post-it® Note in accordance with embodiments herein;

FIG. 1C is a diagram schematically illustrating a label selection interface in accordance with embodiments herein;

FIG. 1D is a diagram schematically illustrating a note selection interface in accordance with embodiments herein;

FIG. 1E is a diagram schematically illustrating an item selection interface in accordance with embodiments herein;

FIG. 2A is a diagram schematically illustrating an environment in which an authenticated end user uses their smartphone to scan a QR code on a Post-it® Note located on manufacturing machinery in accordance with embodiments herein;

FIG. 2B is a diagram schematically illustrating an authentication interface in accordance with embodiments herein;

FIG. 2C is a diagram schematically illustrating the end user of FIG. 2B scanning a QR code on a Post-it® Note in accordance with embodiments herein;

FIG. 2D is a diagram schematically illustrating the end user of FIG. 2C being provided content based upon their prior authentication depicted in FIG. 2B in accordance with embodiments herein;

FIG. 3A is a diagram schematically illustrating a second end user scanning a QR code on a Post-it® Note in accordance with embodiments herein;

FIG. 3B is a diagram schematically illustrating the end user of FIG. 3A being provided content based upon their prior authentication in accordance with embodiments herein;

FIG. 4 is a flow diagram schematically illustrating a method for configuring end user access for a QR code in accordance with embodiments herein;

FIG. 5 is a flow diagram schematically illustrating a method for an end user accessing secure data based upon previous authentication and QR code configuration data in accordance with embodiments herein; and

FIG. 6 is a block diagram of computing hardware utilized to implement various embodiments herein.

### DETAILED DESCRIPTION

The present disclosure describes techniques for using scannable identifiers, such as QR codes, to provide users with access to data depending upon prior authentication. Rather than having an end user merely scan a QR code to directly provide them with access to data, prior authentication of end users provides a significant technical advantage by allowing a variety of previously-authenticated end users to not only access to the data, but to modify that data while providing data security based upon proper end user authentication. This may be conveniently configured by an initializing user that can configure read and edit access for end users by virtue of end users being already authenticated prior to scanning the identifier. The initializing user may place or direct others to place scannable identifiers at locations and/or upon objects, such that the location or type of object bearing the scannable identifier may factor into what data can be accessed. This can help eliminate less secure practices, such as account sharing among end users, thus creating a more secure and customizable end user experience based upon scannable identifiers being utilized at the most relevant places.

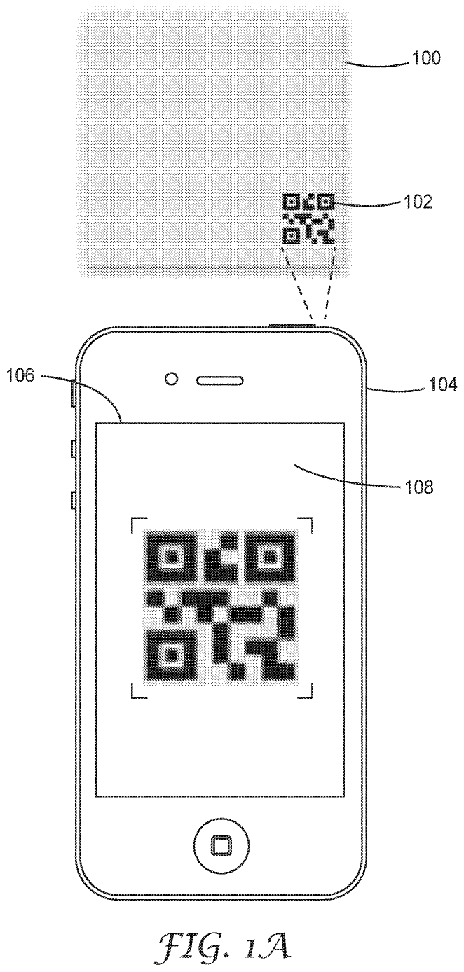

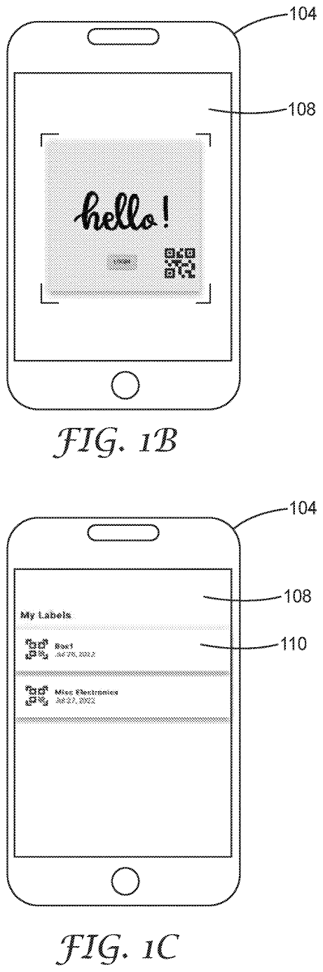

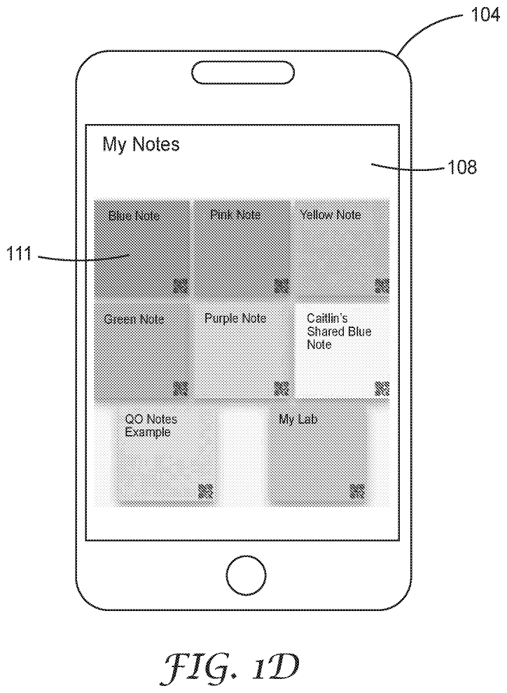

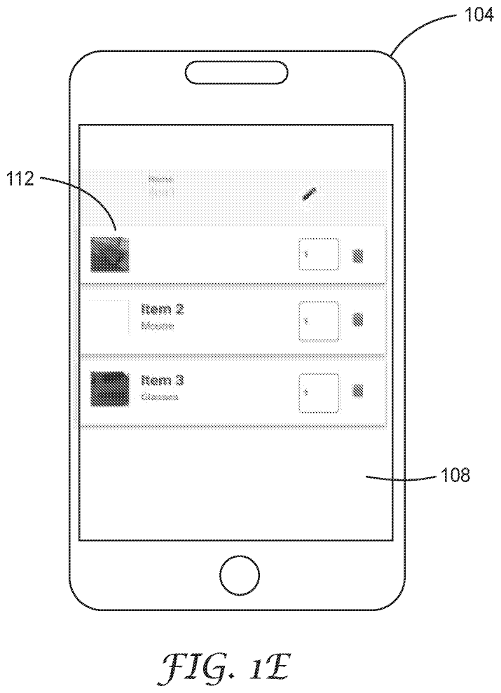

Referring now to FIG. 1A, a smartphone is depicted scanning a QR code located on a Post-it® Note. While a removable physical item 100 in this embodiment is a Post-it® Note, any suitable surface or object capable of displaying a scannable identifier 102 in a manner that makes it scannable may be utilized. By way of non-limiting example, a physical item 100 may include any type of suitable object/surface (paper, plastic, wood, laminated, metal, 3d-printed, electronic displays, electronic paper, hologram, and the like) and/or capable of displaying the contents of a projection (laser, light, and the like). The physical item may be permanently affixed or removably affixed in any suitable manner such as adhesively affixed, magnetically affixed, affixed via static cling, and/or any other suitable type of adhesion. In embodiments, a scannable identifier 102 may include a QR code, a barcode, or any other identifier capable of being recognized by any type of device capable of recognizing a scannable identifier 102. As discussed in more detail below, the scannable identifier 102 may be utilized to provide access to secure data governed by labels and/or items as specified by the configuration data.

Although an exemplary smartphone is depicted in this non-limiting embodiment, the scanning device(s) 104 may include, by way of non-limiting examples, a desktop, laptop, server, client, tablet, smartphone, computing cloud or any other type of device that can capture or otherwise recognize a scannable identifier 102, a physical item 100, and/or an object bearing the scannable identifier 102 with or without a physical item 100 (which may in some embodiments include the scannable identifier 102 being imprinted or projected onto an object without use of a physical item 100). Any suitable interface 108, such as a graphical user interface, may be displayed upon a display 106 of the scanning device 104 to display recognition/capture of the scannable identifier 102. Any suitable type of feedback may optionally be utilized to provide various types of confirmation that a scannable identifier 102 has been recognized, including but not limited to visual confirmation on the interface 108 (such as a camera view or recreated version of the scannable identifier 102), audio/spoken notification, haptic feedback, and the like.

Referring now to FIG. 1B, a welcome interface is displayed based upon the scanning of a QR code on a Post-it® Note. Any suitable type of interface 108 may be utilized to allow an initializing user to set up configuration data after using a scanning device 104 to scan the scannable identifier 102. In various embodiments, an application interface or a mobile app may utilize authentication configuration functions and content acquisition and edit functions. The interface 108 may provide a welcome screen, authentication/login interface, and/or the like. In some embodiments, the initializing user may create an account based upon being the first user to scan the scannable identifier 102. The initializing user may also require additional account creation information, such as by way of non-limiting example, an alpha-numeric code provided with the removable physical item 100, or any other suitable type of authentication data.

Referring now to FIG. 1C, a label selection interface is depicted. In embodiments, the interface 108 may provide labels 110, notes (shown in FIG. 1D), and the like as a digital representation of a removable physical item 100. Once the initializing user account has been established, the interface 108 may allow initializing users to create various labels 110. In some embodiments, configuration data such as a label 110 or note 111 may pertain to a particular type of access for one or more end users. In embodiments, a label 110 or note 111 may be created/edited/deleted by the initializing user for end users authenticated according to any suitable criteria. Non-limiting examples of end user authentication may include authentication onto a corporate network (e.g., directory services (such as Active Directory, OpenLDAP, Apache Directory, Domino, and the like),) that may include a certain type of role assigned to the end user, authentication on a wi-fi network, social media profile authentication, authentication based upon being at a particular location when scanning the QR code, and/or any other suitable authentication criteria. For example, one label 110 or note 111 could be created for users with directory service profiles having a managerial role. Another label 110 or note 111 could be created for users whose directory service profile is associated with a manufacturing plant in which the QR code being scanned is located (using location data from the scanning device 104, for example). Yet another label 110 or note 111 could be created for any (or certain) end users who are authenticated onto a network (wi-fi, directory service, workgroup, IP address, and the like) at one or more specified locations (a group of manufacturing plants belonging to a business division, by way of non-limiting example). In other embodiments, an end user may be authenticated using social media account contacts in the scanning device 104 by having the end user authenticate by verifying the device ID such as using face recognition or a passcode. In still other embodiments, an end user may be authenticated based upon the end user's age, end user's address, completion of any required training, an end user's status in a shopping reward program, and the like.

Referring now to FIG. 1D, a note 111 selection interface is depicted. In embodiments, the interface 108 may provide labels 110, notes 111 and the like as a digital representation of a removable physical item 100. Once the initializing user account has been established, the interface 108 may allow initializing users to create various notes 111. In some embodiments, configuration data such as a note 111 may pertain to a particular type of access for one or more end users. In embodiments, a note 111 may be created/edited/deleted by the initializing user for end users authenticated according to any suitable criteria discussed herein.

Referring now to FIG. 1E, an item 112 selection interface is depicted. By way of non-limiting example, within a given label 110 or note 111, initializing users may add/edit/delete data of any type of content to be associated with any number of items 112, such as text, photos, graphics, videos, links/URLs, augment reality (AR) content, polls, and the like. In this way, an initializing user can create a custom experience for managers (e.g., previously authenticated within the corporate directory service on their smartphone) to be provided access to the items 112 associated with the label 110 or note 111 as created/modified by the initializing user.

By way of non-limiting example, a label may allow an end user to be able to view secure augmented reality content at a specified location, such as (for manufacturing machinery) operating instructions that float in augmented reality on the smartphone of a user once they utilize a QR code located on a Post-it® Note affixed to the manufacturing machinery. In other embodiments, an initializing user and/or an end user utilizing an augmented reality headset may be able to configure and/or utilize augmented reality content. Moreover, the initializing user may designate edit access to data for end users. By way of non-limiting example, the initializing user may, within with a label 110 or note 111 for all plant employees, allow a plant manager (based on prior authentication that is still valid) to edit the items 112 associated with the label 110 or note 111 (such as making additional notes or modifying images). By contrast, non-supervisory employees may not be given edit access to the items 112 associated with the label 110 or note 111. In some embodiments, non-supervisory employees may not even be able to access some or all of the items 112, depending on how the initializing user sets up access associated with the label 110 or note 111.

In some embodiments, speech recognition may be utilized to allow the initializing user to set up labels 110 and/or items 112 and/or create text content within labels 110 and/or items 112. In embodiments, speech recognition may be implemented with respect to any suitable features discussed herein. By way of non-limiting example, the initializing user may speak instructions for authenticated managers to be provided with the ability to edit operating instructions pertaining to a piece of manufacturing machinery. Similarly, this would be based upon an authenticated manager scanning a scannable identifier 102 located on a physical item 100, which is currently or will be affixed to the manufacturing machinery. In other embodiments, object recognition machine learning and/or artificial intelligence may be utilized. In embodiments, object recognition may be implemented with respect to any suitable features discussed herein. By way of non-limiting example, the initializing user may specify items 112 based upon what is identified as being currently being viewed in the camera of their smartphone as a result of object recognition, such as manufacturing machinery. By having the exemplary manufacturing machinery recognized by object recognition, items 112 such as operating instructions, related financial data, photos, and the like can be automatically associated with the manufacturing machinery or suggested for inclusion for association with the manufacturing machinery. In this way, if an end user scans a scannable identifier 102 located on a removable physical item 100 affixed to the manufacturing machinery (or in combination in some embodiments) with the location of the smartphone at the time of the scan, the end user can be provided with read or edit access to items 112 associated with the manufacturing machinery.

In various embodiments, object recognition may be utilized to automatically suggest or provide content to the end user. In embodiments, speech recognition may be implemented with respect to any suitable features discussed herein. One or more neural networks may be utilized for a variety of machine learning-related tasks described herein, such as object recognition/classification. By way of example, the neural network may utilize one or more artificial neural networks (ANNs). In ANNs, connections between nodes may form a directed acyclic graph (DAG). ANNs may include node inputs, one or more hidden activation layers, and node outputs, and may be utilized with activation functions in the one or more hidden activation layers such as a linear function, a step function, logistic (sigmoid) function, a tanh function, a rectified linear unit (ReLu) function, or combinations thereof. ANNs are trained by applying such activation functions to training data sets to determine an optimized solution from adjustable weights and biases applied to nodes within the hidden activation layers to generate one or more outputs as the optimized solution with a minimized error.

In machine learning applications, new inputs may be provided (such as the generated one or more outputs) to the ANN model as training data to continue to improve accuracy and minimize error of the ANN model. The one or more ANN models may utilize one to one, one to many, many to one, and/or many to many (e.g., sequence to sequence) sequence modeling. Such ANN models may include artificial intelligence components selected from the group that may include, but not be limited to, an artificial intelligence engine, Bayesian inference engine, and a decision-making engine, and may have an adaptive learning engine further comprising a deep neural network learning engine. The one or more ANN models may employ a combination of artificial intelligence techniques, such as, but not limited to, Deep Learning, Random Forest Classifiers, Feature extraction from natural language input to the processing engine and/or the data map, audio, images, clustering algorithms, bounding box algorithms, or combinations thereof.

In embodiments, a convolutional neural network (CNN) may be utilized. For example, a convolutional neural network (CNN) may be used as an ANN that, in a field of machine learning, for example, is a class of deep, feed-forward ANNs applied for adjuster assignment weights. CNNs may be shift or space invariant and utilize shared-weight architecture and translation invariance characteristics. Additionally or alternatively, a recurrent neural network (RNN) may be used as an ANN that is a feedback neural network. RNNs may use an internal memory state to process variable length sequences of inputs to generate one or more outputs. In RNNs, connections between nodes may form a DAG along a temporal sequence. One or more different types of RNNs may be used such as a standard RNN, a Long Short Term Memory (LSTM) RNN architecture, and/or a Gated Recurrent Unit RNN architecture. Embodiments may include artificial intelligence components selected from the group consisting of an artificial intelligence engine, Bayesian inference engine, and a decision-making engine, and may have an adaptive learning engine further comprising a deep neural network-learning engine. It is contemplated and within the scope of this disclosure that the term “deep” with respect to the deep neural network-learning engine is a term of art readily understood by one of ordinary skill in the art.

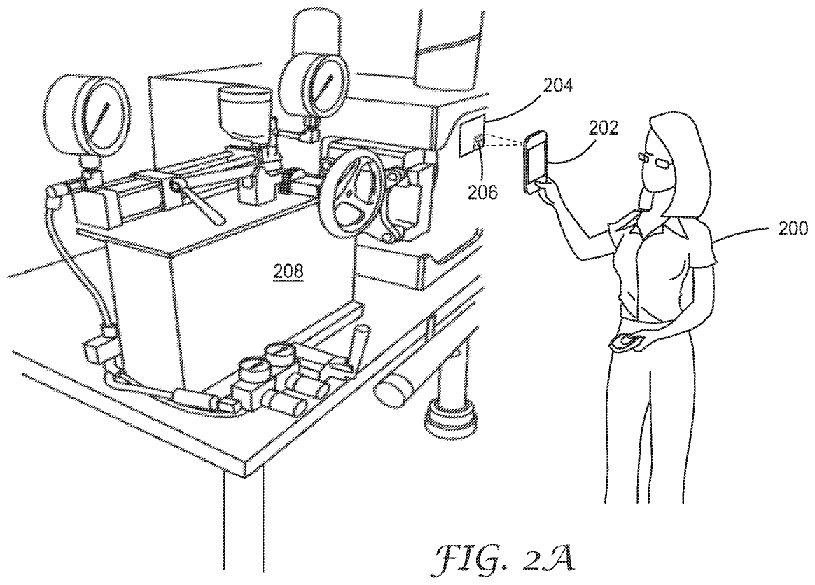

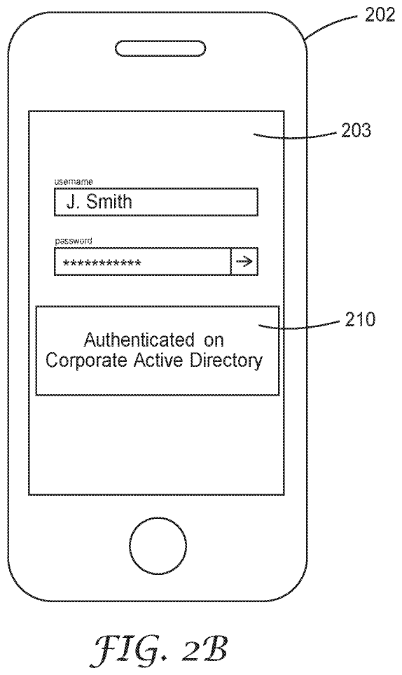

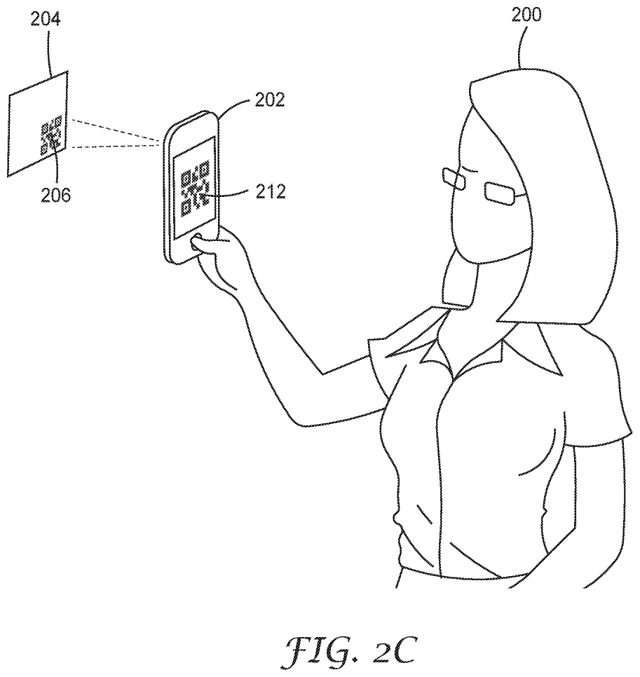

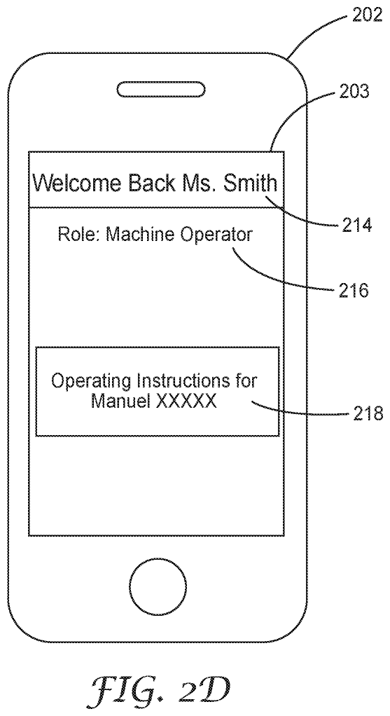

Referring now to FIG. 2A, an environment is depicted in which an authenticated end user uses their smartphone to scan a QR code on a Post-it® Note located on manufacturing machinery. In this non-limiting example, the user 200 previously authenticated onto their corporate directory service using their scanning device 202 (e.g., a smartphone) and is presently authenticated as the manager of the plant in which the object 208 (e.g., manufacturing machinery) is located. Affixed to the object 208 is a removable physical item 204 (a Post-it® Note in this non-limiting example) having a scannable identifier 206 (a QR code in this non-limiting example) located thereon. By way of non-limiting example, the scannable identifier 206 may relate to the object 208 in a specific location. In that example, if the physical item 204 were relocated or otherwise removed, scanning the scannable identifier 206 at another location would return an error message based upon a discrepancy in the location data from the scanning device 202 at the time of scanning and result in outputting a notification to the user requesting that they reaffix the physical item 204 to the object 208, and/or any other suitable notifications/instructions.

Referring now to FIG. 2B, an authentication interface is depicted. In this embodiment, as shown on the display 203 of the scanning device 202, the user 200 has entered authentication information, here a username and password, although any suitable type of authentication or combination of types of authentication may be utilized, such as two-factor authentication, random number generation, biometrics, and the like. An authentication indicator 210 may be displayed to indicate to the user 200 that they have been authenticated, but in some embodiments this may be not be provided. In other embodiments, authentication may be based upon authentication onto a corporate network that may include a certain type of role assigned to the end user, authentication on a wi-fi network, social media profile authentication, authentication based upon being at a particular location when scanning the QR code, end user's age, end user's address, completion of any required training, end user's status in a shopping reward program, and/or any other suitable authentication criteria.

Referring now to FIG. 2C, the end user of FIG. 2B is depicted scanning a QR code on a Post-it® Note, wherein secure content access may be determined by access configuration. Here, the end user 200 was previously authenticated on their corporate directory service as the manager of a manufacturing plant and is now using their scanning device 202 to scan a scannable identifier 206 located on a removable physical item 204 located within the plant.

Referring now to FIG. 2D, the end user of FIG. 2C is depicted being provided content based upon their prior authentication depicted in FIG. 2B, wherein secure content access may be determined by access configuration. Now that the end user 200 has scanned scannable identifier 206 after having been previously authenticated within their role as plant manager, the end user 200 is provided a user identifier 214 on the display 203 of their scanning device 202, along with confirmation of their user role 216 (e.g., plant manager). Secure content 218 may be provided with read, edit, and/or delete access to the user 200, depending on the prior configuration of the labels and items associated with the scannable identifier 206 as configured by the initializing user. As used herein, configuration input and configuration data may refer to input provided by the initializing user to configure the labels and/or items associated with a QR code, and in some embodiments, may include end users delegated such configuration authority. In this example, the end user 200, by virtue of being a plant manager, is given edit access to the secure content 218 (e.g., operating instructions) for the object 208 (e.g., manufacturing machinery) as a decision maker of what a machine operator should have access to within the secure content 218. By contrast, a machine operator after authenticating onto the corporate directory service via their scanning device 202, may then only be able to see what the plant manager designated for them to be able to view. In some embodiments, an end user 200 may, if given edit access to the secure content 218, may further delegate edit access to other end users 200 (whether based on role, name, etc.) which may be revocably or irrevocably granted depending in various embodiments.

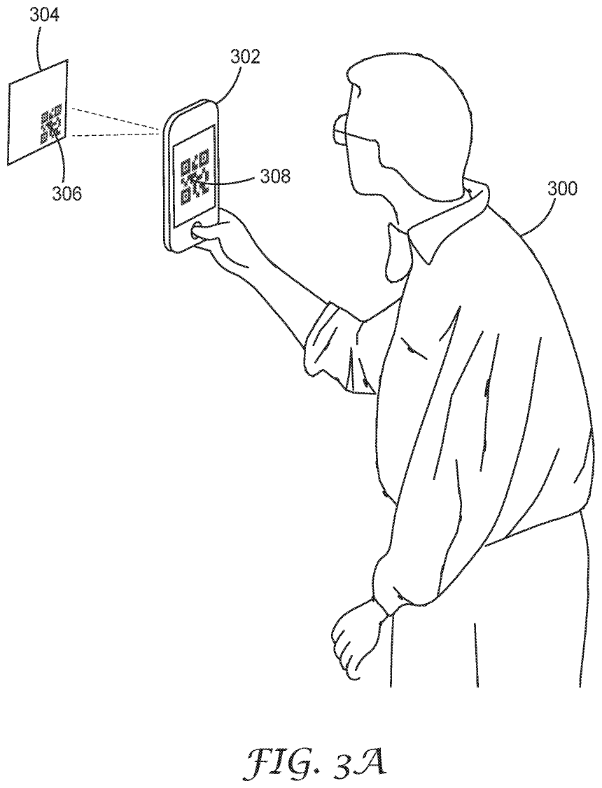

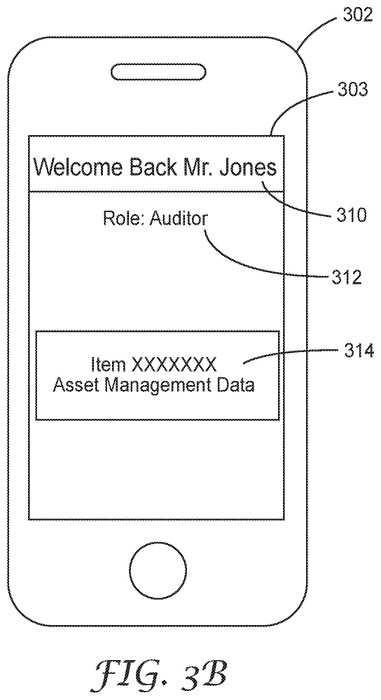

Referring now to FIG. 3A, a second end user is depicted scanning a QR code on a Post-it® Note. In this embodiment, an end user 300 uses their scanning device 302 to scan the scannable identifier 306 located on a removable physical item 304, such that a version of the QR code is displayed on the scanning device 302 as a displayed identifier 308.

Referring now to FIG. 3B, the end user of FIG. 3A is depicted being provided content based upon their prior authentication. Here, the end user 300 is provided on the screen 303 of their scanning device 302 a user identifier 310 and confirmation of their user role 312. In this non-limiting example, the end user 300 is a corporate auditor that has scanned the same scannable identifier 306 located on the same removable physical item 304 located on the same manufacturing machinery discussed with respect to FIGS. 2A-2D. The secure content 314 here, however, has been configured by the initializing user to be asset management data pertaining to the manufacturing machinery. This is different from the operating instructions accessed by the plant manager in FIGS. 2A-2D, due to the end user 300 here being a corporate auditor. In some embodiments, the second user may be able to edit data that is different from (or a subset of) the data to which the first end user has edit access.

Referring now to FIG. 4, a flowchart for configuring end user access for a QR code according to one embodiment is depicted. At block 400, an initializing user may scan a QR code. At block 402, the initializing user may log in. At block 404, the initializing user may then provide configuration data for data provided to each end user for the QR code, such as creating and/or editing labels and/or items associated with the QR code.

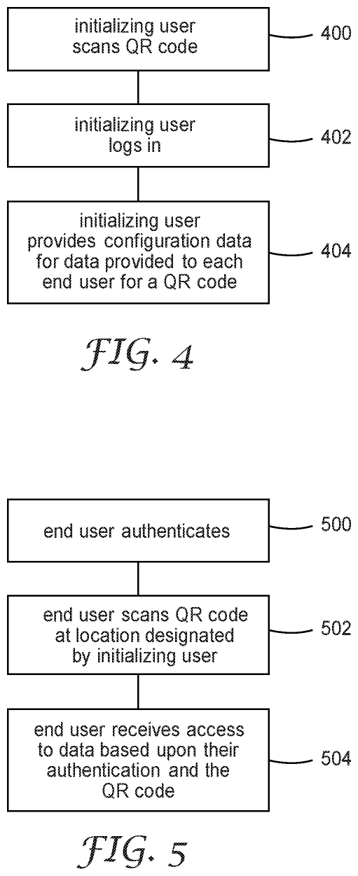

Referring now to FIG. 5, a flowchart for an end user accessing data based upon previous authentication and QR code configuration data according to one embodiment is depicted. At block 500, an end user authenticates onto a platform such as a directory service, a workgroup, a wi-fi network, using their IP address, or the like. At block 502, the end user may scan a scannable identifier, such as a QR code, at a location corresponding to location data specified by the initializing user as part of the configuration data. At block 504, the end user may receive access to data (or secure data) based upon their previous authentication as well as their scanning of the scannable identifier.

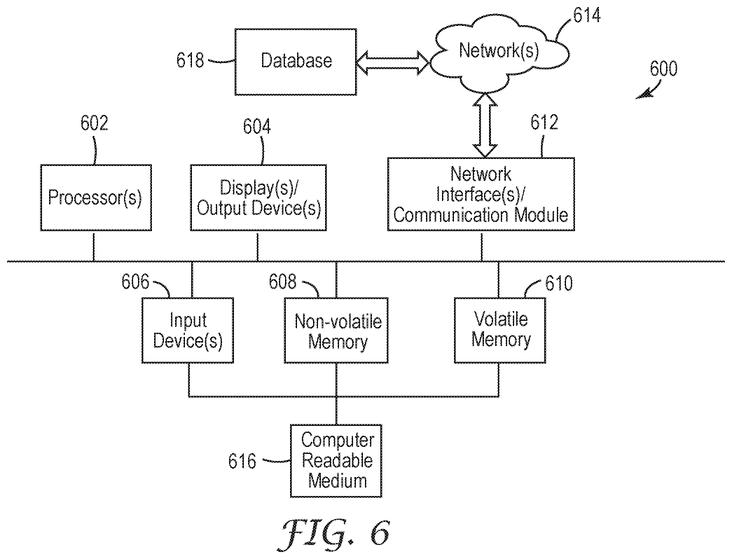

Referring now to FIG. 6, a block diagram illustrates computing hardware, such as an exemplary computing device 600, through which embodiments of the disclosure can be implemented. The computing device 600 described herein is but one example of a suitable computing device and does not suggest any limitation on the scope of any embodiments presented. Nothing illustrated or described with respect to the computing device 600 should be interpreted as being required or as creating any type of dependency with respect to any element or plurality of elements. In various embodiments, the computing device 600 may include, but need not be limited to, a desktop, laptop, server, client, tablet, smartphone, computing cloud or any other type of device that can utilize data. In an embodiment, the computing device 600 includes at least one processor 602 and memory comprising non-volatile memory 608 and/or volatile memory 610. The computing device 600 can include one or more displays, display hardware, and/or output devices 604 such as, for example, AR/VR/MR/XR hardware, monitors, speakers, headphones, projectors, wearable-displays, holographic displays, and/or printers. Output devices 604 may further include, for example, displays and/or speakers, devices that emit energy (radio, microwave, infrared, visible light, ultraviolet, x-ray and gamma ray), electronic output devices (Wi-Fi, radar, laser, etc.), audio (of any frequency), and the like.

The computing device 600 may further include one or more input devices 606 which can include, by way of example, any type of mouse, keyboard, disk/media drive, memory stick/thumb-drive, memory card, pen, touch-input device, biometric scanner, gaze and/or blink tracker, tracker, voice/auditory input device, motion-detector, camera, scale, and any device capable of measuring data such as motion data (e.g., an accelerometer, GPS, a magnetometer, a gyroscope, etc.), biometric data (e.g., blood pressure, pulse, heart rate, perspiration, temperature, voice, facial-recognition, motion/gesture tracking, gaze tracking, iris or other types of eye recognition, hand geometry, oxygen saturation, glucose level, fingerprint, DNA, dental records, weight, or any other suitable type of biometric data, etc.), video/still images, and audio (including human-audible and human-inaudible ultrasonic sound waves). Input devices 606 may include any type of device capable of receiving data, whether from another device, visual and/or audio data captured from the real world, object detection data, and the like. Input devices 606 may include cameras (with or without audio recording), such as digital and/or analog cameras, still cameras, video cameras, thermal imaging cameras, infrared cameras, cameras with a charge-couple display, night-vision cameras, three-dimensional cameras, webcams, audio recorders, and the like.

The computing device 600 typically includes non-volatile memory 608 (e.g., ROM, flash memory, etc.), volatile memory 610 (e.g., RAM, etc.), or a combination thereof. A network interface 612 can facilitate communications over a network 614 with other data source such as a database 618 via wires, a wide area network, a local area network, a personal area network, a cellular network, a satellite network, and the like. Suitable local area networks may include wired Ethernet and/or wireless technologies such as, for example, wireless fidelity (Wi-Fi). Suitable personal area networks may include wireless technologies such as, for example, IrDA, Bluetooth, Wireless USB, Z-Wave, ZigBee, and/or other near field communication protocols. Suitable personal area networks may similarly include wired computer buses such as, for example, USB and FireWire. Suitable cellular networks may include, but are not limited to, technologies such as LTE, WiMAX, UMTS, CDMA, and GSM. Network interface 612 can be communicatively coupled to any device capable of transmitting and/or receiving data via one or more network(s) 614. Accordingly, the network interface 612 can include a communication transceiver for sending and/or receiving any wired or wireless communication. For example, the network interface 612 may include an antenna, a modem, LAN port, Wi-Fi card, WiMax card, mobile communications hardware, near-field communication hardware, satellite communication hardware and/or any wired or wireless hardware for communicating with other networks and/or devices.

A computer-readable medium 616 comprises one or more plurality of computer readable mediums, each of which is non-transitory. A computer readable medium may reside, for example, within an input device 606, non-volatile memory 608, volatile memory 610, or any combination thereof. A readable storage medium can include tangible media that is able to store instructions associated with, or used by, a device or system. A computer readable medium, also referred to herein as a non-transitory computer readable medium, includes, by way of non-limiting examples: RAM, ROM, cache, fiber optics, EPROM/Flash memory, CD/DVD/BD-ROM, hard disk drives, solid-state storage, optical or magnetic storage devices, diskettes, electrical connections having a wire, or any combination thereof. A non-transitory computer readable medium may also include, for example, a system or device that is of a magnetic, optical, semiconductor, or electronic type. A non-transitory computer readable medium excludes carrier waves and/or propagated signals taking any number of forms such as optical, electromagnetic, or combinations thereof.

The computing device 600 may include one or more network interfaces 612 to facilitate communication with one or more remote devices, which may include, for example, client and/or server devices. The network interface 612 may also be described as a communications module, as these terms may be used interchangeably. The database 618 is depicted as being accessible over the network 614 and may reside within a server, the cloud, or any other configuration to support being able to remotely access data and store data in the database 618.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

While particular embodiments have been illustrated and described herein, it should be understood that various other changes and modifications may be made without departing from the scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. One or more non-transitory computer-readable storage media encoded with instructions that, when executed, configure processing circuitry of a computing device to:
output a removable scannable identifier that is displayed on a physical item;
configure the scannable identifier, based upon received configuration input, to grant edit access to specified data based upon subsequent end user authentication;
receive, from a first end user, scan data corresponding to the scannable identifier and first end user authentication data; and
provide, to the first end user, edit access to the specified data based upon the received scan data and first end user authentication data.

2. The one or more non-transitory computer-readable storage media of claim 1 encoded with further instructions wherein the configuration input is received from an initializing user that is different from the first end user.

3. The one or more non-transitory computer-readable storage media of claim 1 encoded with further instructions wherein the first end user authentication data is via wi-fi, directory service, IP address, workgroup, social media account data, device identification data, or any combination thereof.

4. The one or more non-transitory computer-readable storage media of claim 1 encoded with further instructions wherein the first end user authentication data is based upon location data of the scan data.

5. The one or more non-transitory computer-readable storage media of claim 1 encoded with further instructions wherein the first end user is granted access that differs from access granted to a second end user that has scanned the scannable identifier.

6. The one or more non-transitory computer-readable storage media of claim 5 encoded with further instructions wherein the first end user has a role granting access that differs from access granted to a second end user having a role that differs from the role of the first end user.

7. The one or more non-transitory computer-readable storage media of claim 1 encoded with further instructions wherein the physical item is configured to be removable from an object and adhesively affixed, magnetically affixed, or affixed with static the object.

8. The one or more non-transitory computer-readable storage media of claim 7 encoded with further instructions to grant the first end user edit access to the specified data pertaining to the object;

9. The one or more non-transitory computer-readable storage media of claim 1 encoded with further instructions wherein the configuration input comprises data obtained via speech recognition.

10. The one or more non-transitory computer-readable storage media of claim 1 encoded with further instructions wherein the configuration input comprises object recognition from a camera used to scan the scannable identifier.

11. The one or more non-transitory computer-readable storage media of claim 1 encoded with further instructions wherein the configuration input comprises location information, end user role information, end user authentication data, or any combination thereof.

12. The one or more non-transitory computer-readable storage media of claim 1 encoded with further instructions wherein outputting the scannable identifier upon the physical item is based upon input received from an initializing user providing the configuration input.

13. A computing device comprising:
a memory and a processor, wherein the memory is coupled to the processor with the processor being configured to perform operations to:
output a removable scannable identifier that is display on a physical item;
configure the scannable identifier, based upon received configuration input, to grant edit access to specified data based upon subsequent end user authentication;
receive, from a first end user, scan data corresponding to the scannable identifier and first end user authentication data; and
provide, to the first end user, edit access to the specified data based upon the received scan data and first end user authentication data.

14. The computing device of claim 13 comprising further instructions wherein the configuration input is received from an initializing user that is different from the first end user.

15. The computing device of claim 13 comprising further instructions wherein the first end user authentication data is based upon location data of the scan data.

16. The computing device of claim 13 comprising further instructions wherein the first end user is granted access that differs from access granted to a second end user that has scanned the scannable identifier.

17. The computing device of claim 16 comprising further instructions wherein the first end user has a role granting access that differs from access granted to a second end user having a role that differs from the role of the first end user.

18. The computing device of claim 13 comprising further instructions wherein the physical item is configured to be removable from an object and adhesively affixed, magnetically affixed, or affixed with static the object.

19. A method comprising:
outputting a removable scannable identifier that is displayed on a physical item;
configuring the scannable identifier, based upon received configuration input, to grant edit access to specified data based upon subsequent end user authentication;
receiving, from a previously-authenticated first end user, scan data corresponding to the scannable identifier and first end user authentication data; and
providing, to the first end user, edit access to the specified data based upon the received scan data and first end user authentication data.

20. The method of claim 19 wherein the configuration input is received from an initializing user that is different from the first end user.
